(19) United States
(12) Patent Application Publication
(10) Pub. No.: US 2021/0162420 A1
(43) Pub. Date: Jun. 3, 2021

(54) Lab-on-a-Chip Analysis Device and Housing for a Lab-on-a-Chip Analysis Device

(71) Applicant: Robert Bosch GmbH, Stuttgart (DE)

(72) Inventor: Karsten Seidl, Mülheim an der Ruhr (DE)

(21) Appl. No.: 17/047,151

(22) PCT Filed: Apr. 18, 2019
(86) PCT No.: PCT/EP2019/060065

§ 371 Date: Oct. 13, 2020

(30) Foreign Application Priority Data
Apr. 20, 2018 (DE) 10 2018 206 060.6

(51) Int. Cl. B01L 9/00

(52) U.S. Cl. CPC B01L 9/527; B01L 2300/021; B01L 2300/0816; B01L 2300/027; B01L 2300/023

(57) ABSTRACT

A housing for a chip laboratory analysis device has a cartridge opening for introducing a cartridge with material to be analyzed into the chip laboratory analysis device. The housing also includes a rear side with a connection opening for connecting a cable for power supply to the chip laboratory analysis device. In addition, the housing has a standing surface side with a maintenance interface for maintaining the chip laboratory analysis device. The standing surface side is shaped in order to function as a standing surface for the chip laboratory analysis device when the chip laboratory analysis device is in operation. The rear side is shaped in order to function as a further standing area for the chip laboratory analysis device when the cable is removed from the connection opening and when the chip laboratory analysis device is being maintained.

### PRIOR ART

The invention starts out from a device of the generic type of the independent claims.

In vitro diagnostics (IVD) is a field of medical products which, from human samples, measure specific parameters such as a concentration of a molecule, the presence of a defined DNA sequence or a composition of blood, etc., in order to permit a diagnosis and a treatment decision. This can take place in a chain of several laboratory steps, wherein a sample can be conditioned such that a target parameter is measurable without interference. Various laboratory methods can be applied, each using analysis equipment suitable for the specific procedure. In devices close to the patient, so-called point-of-care devices, the aim may be, for example, to carry out such in vitro diagnostic tests in one device and reduce to a minimum the number of manual steps performed by the user. The sample can be introduced into a disposable cartridge. After the cartridge has been placed into the analysis device, the diagnostic test can be processed fully automatically. Such analysis devices may have components that require maintenance, for example air filters or sealing lips. Such devices may also be opened during maintenance work, e.g. for adjustment of optical elements. Particularly if electrical voltages of 100 to 230 volts, for example, are applied to the analysis device, e.g. by means of cold appliance plugs, these should be separated for safety reasons before the analysis device is opened.

### DISCLOSURE OF THE INVENTION

Against this background, the approach presented here proposes a housing for a lab-on-a-chip analysis device, and a lab-on-a-chip analysis device, according to the main claims. With the measures set forth in the dependent claims, advantageous developments and improvements of the device according to the independent claim are possible.

According to embodiments, a structural design or configuration of a housing for a lab-on-a-chip analysis device can in particular be provided in order to enforce or at least encourage a separation of an electrical energy supply during maintenance work with partial or complete opening of the device. For example, the housing can be configured such that an access for the energy supply and an access to the interior of the lab-on-a-chip analysis device, and additionally or alternatively to components that require maintenance, are arranged at different sides of the device. By virtue of a shape of the housing, it is possible to perform maintenance work in particular by necessitating and encouraging a change-over from a standing surface of the lab-on-a-chip analysis device, on which the access to the interior of the device and additionally or alternatively to components that require maintenance is arranged, to the surface or side having the access for the energy supply.

Advantageously, according to embodiments, a housing for a lab-on-a-chip analysis device can in particular be configured in such a way that a safe separation of an electrical energy supply can be achieved during maintenance work. By means of a geometry of the housing, it is possible to require and to encourage that the lab-on-a-chip analysis device is switched to a voltage-free state by pulling out a power cable from the device before the lab-on-a-chip analysis device can be tilted, for maintenance work, to the side having the access for the energy supply, in order to reach the access to the interior of the device and additionally or alternatively the access to components that require maintenance. Particularly when replacing air filter elements, for example filter mats, it is thus possible for a fan first of all to be stopped, for example before a flap functioning as an access is removed with the filter element that is to be replaced, as a result of which the fan, which rotates when supplied with voltage, can be reliably stopped. User safety when performing maintenance work can thus be increased. By enforcing or encouraging the separation of the energy supply, it is possible to prevent a situation where a user or service technician, performing maintenance work with the device partially or completely open, touches voltage-carrying components and, additionally or alternatively, moving parts.

A housing for a lab-on-a-chip analysis device is proposed, wherein the housing has the following features:

a cartridge opening for inserting a cartridge, with material to be analyzed, into the lab-on-a-chip analysis device;

a rear side having a connection opening for connecting an energy supply cable to the lab-on-a-chip analysis device; and

a standing surface side having a maintenance interface for carrying out maintenance on the lab-on-a-chip analysis device, wherein the standing surface side is configured to function as a standing surface of the lab-on-a-chip analysis device during operation of the lab-on-a-chip analysis device, wherein the rear side is configured to function as a further standing surface of the lab-on-a-chip analysis device when the cable is removed from the connection opening and the lab-on-a-chip analysis device is undergoing maintenance.

The housing can be configured to accommodate the lab-on-a-chip analysis device completely or to a large extent. The cartridge can be a microfluidic lab-on-a-chip cartridge. The cartridge opening can be arranged, for example, on the front side or top side of the housing. The connection opening can be configured as a passage extending through the housing for the insertion of a plug of the cable. A connector socket of the lab-on-a-chip analysis device can be accessible through the connection opening, or the connection opening can be configured as such a connector socket. The plug can be a cold appliance plug. The maintenance interface can be configured to permit access to at least one component of the lab-on-a-chip analysis device requiring maintenance.

According to one embodiment, the rear side and the standing surface side can be surfaces adjoining each other and having a common edge. For maintenance work on the lab-on-a-chip analysis device, a tilting movement can be effected about the common edge. Such an embodiment affords the advantage that a change-over from the standing surface side, as the standing surface during the normal operation of the lab-on-a-chip analysis device, to the rear side, as the further standing surface for maintenance work, can be encouraged or promoted, since it is just a tilting movement from one side to an adjoining side that has to be carried out. The lab-on-a-chip analysis device can be of a size and weight allowing an operator to carry out the tilting movement easily and without aid.

The connection opening can be arranged adjacent to the common edge. To be more exact, the connection opening can be arranged in a third of the rear side of the housing having the common edge. Such an embodiment affords the advantage that a change-over from the standing surface to the further standing surface for maintenance work is permitted only when the cable is pulled out.

The common edge can also be rounded. Such an embodiment affords the advantage that a tilting movement from the standing surface side to the rear side can be facilitated still further.

According to one embodiment, the rear side and the standing surface side can between them span an acute angle or a right angle. Such an embodiment affords the advantage that a secure stance of the lab-on-a-chip analysis device can be achieved even when the further standing surface is being used for maintenance work.

Moreover, the housing can have at least one elastic element which extends over a portion of the standing surface side and additionally or alternatively over a portion of the rear side. Here, at least one elastic element can be configured continuously. The at least one elastic element can be formed both ways from rubber or the like. Such an embodiment affords the advantage that slipping of the lab-on-a-chip analysis device can be avoided. In the case of a continuous configuration of at least one elastic element, which extends over a portion of the standing surface side and over a portion of the rear side, a tilting movement from the standing surface side to the rear side can moreover be assisted.

In particular, the maintenance interface can have at least one flap, by means of which a housing interior, an air filter and additionally or alternatively another functional component of the lab-on-a-chip analysis device can be made accessible for maintenance. Another functional component can be a sealing element for example, in particular a sealing lip or the like. Such an embodiment affords the advantage of permitting simple maintenance of functional components of the lab-on-a-chip analysis device.

The housing can also have a further connection opening for connecting at least one further cable, for data transmission, to the lab-on-a-chip analysis device. The further connection opening can be formed in the rear side of the housing. Such an embodiment affords the advantage that at least one lab-on-a-chip analysis device can be connected for example to a network, a central computer or the like.

Moreover, the housing can have a window for a reader for reading optoelectronically readable symbols. The reader can be a barcode reader for reading barcodes or the like. Such an embodiment affords the advantage that optoelectronically readable symbols arranged on cartridges can be read out in order to permit, for each type of cartridge, a specific analysis by means of the lab-on-a-chip analysis device.

A lab-on-a-chip analysis device having an embodiment of the abovementioned housing is also proposed.

Functional components of the lab-on-a-chip analysis device can here be arranged inside the housing. To put it another way, functional components of the lab-on-a-chip analysis device can be arranged so as to be protected from an environment by the housing.

Illustrative embodiments of the approach presented here are shown in the drawings and are explained in more detail in the description below. In the drawings:

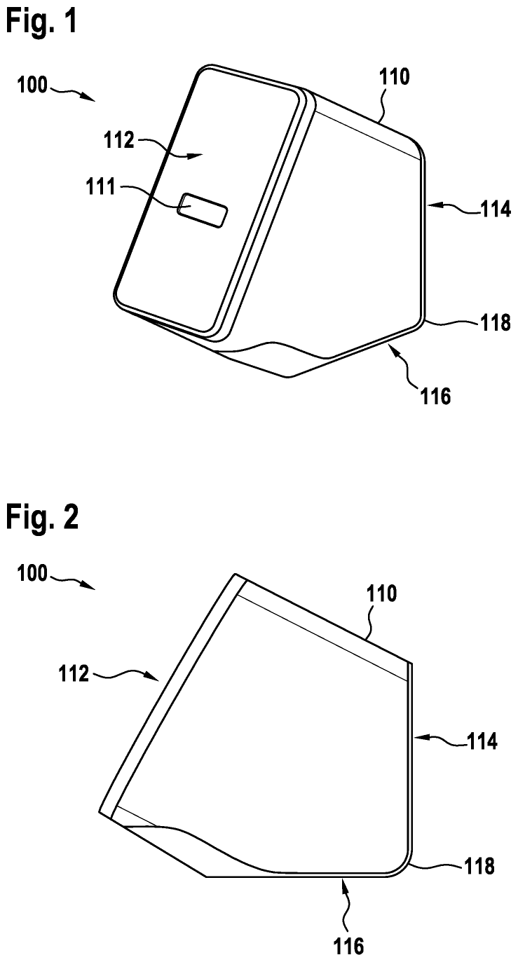

FIG. 1 shows a schematic view of a lab-on-a-chip analysis device according to one illustrative embodiment;

FIG. 2 shows a schematic view of the lab-on-a-chip analysis device of FIG. 1 from another perspective;

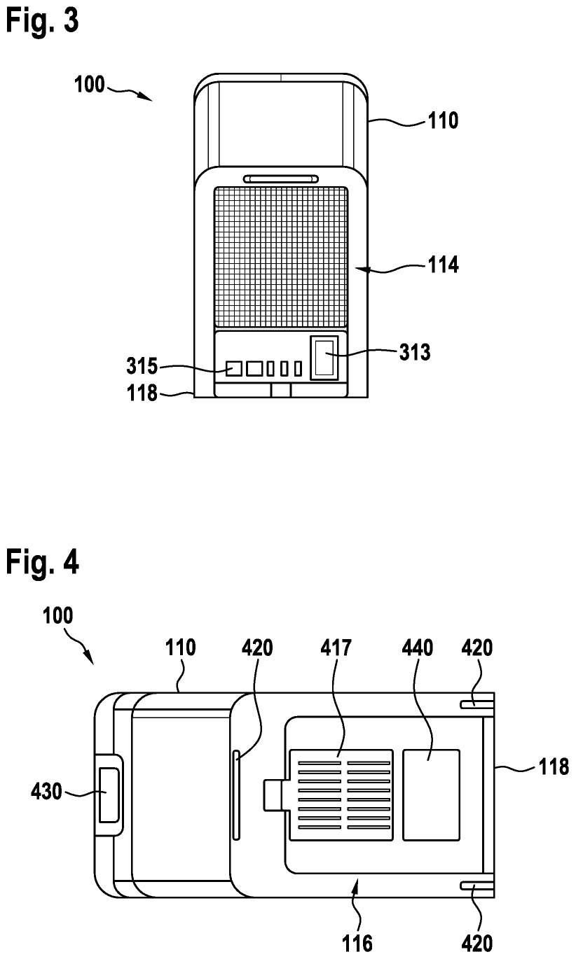

FIG. 3 shows a schematic view of the lab-on-a-chip analysis device of FIG. 1 or FIG. 2 from another perspective;

FIG. 4 shows a schematic view of the lab-on-a-chip analysis device of FIG. 1, FIG. 2 or FIG. 3 from another perspective;

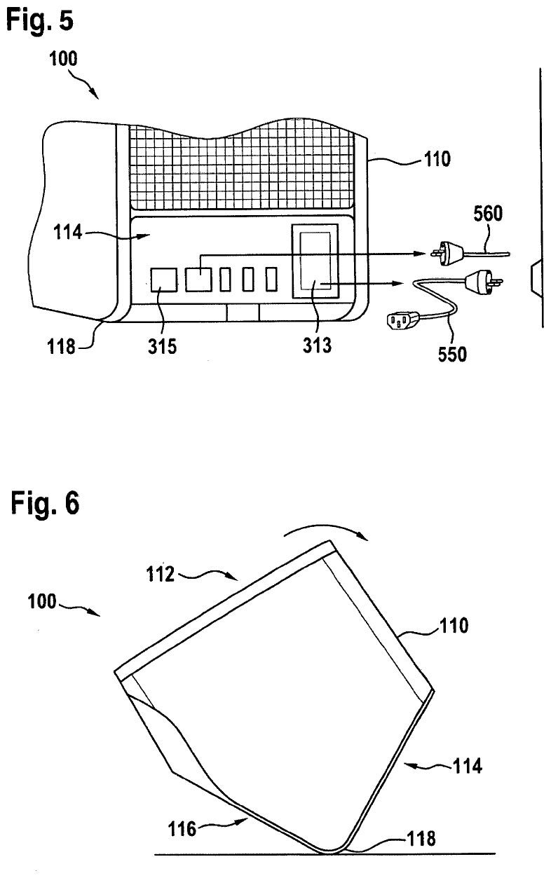

FIG. 5 shows a schematic view of a portion of the lab-on-a-chip analysis device of FIG. 1, FIG. 2, FIG. 3 or FIG. 4;

FIG. 6 shows a schematic view of the lab-on-a-chip analysis device of FIG. 1, FIG. 2, FIG. 3 or FIG. 4 during tilting from the standing surface to the further standing surface;

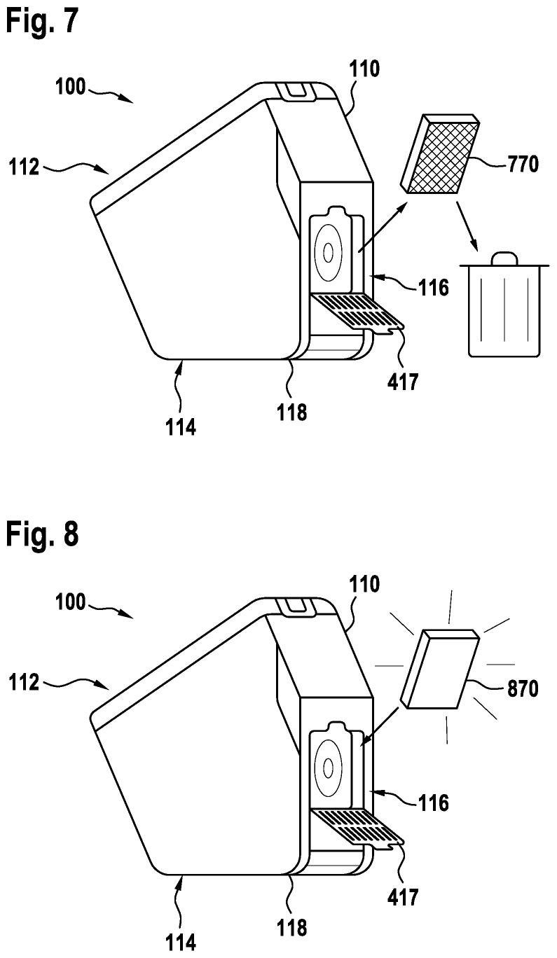

FIG. 7 shows a schematic view of the lab-on-a-chip analysis device of FIG. 1, FIG. 2, FIG. 3, FIG. 4 or FIG. 6 at the start of a maintenance procedure; and

FIG. 8 shows a schematic view of the lab-on-a-chip analysis device of FIG. 1, FIG. 2, FIG. 3, FIG. 4, FIG. 6 or FIG. 7 at the end of the maintenance procedure.

In the following description of expedient illustrative embodiments of the present invention, the elements shown in the various figures and having similar effects are designated by the same or similar reference signs, thereby avoiding repeated description of these elements.

FIG. 1 shows a schematic view of a lab-on-a-chip analysis device 100 according to one illustrative embodiment. The lab-on-a-chip analysis device 100 can be provided for use close to a patient. In this case, the lab-on-a-chip analysis device 100 is designed to analyze material introduced into cartridges. The lab-on-a-chip analysis device 100 has a housing 110 for receiving functional components of the lab-on-a-chip analysis device 100. Here, the lab-on-a-chip analysis device 100, in particular the housing 110, is shown in an oblique front view.

The housing 110 has a front side 112, a rear side 114 and a standing surface side 116. For example, a cartridge opening 111 through which a cartridge with material to be analyzed can be introduced into the lab-on-a-chip analysis device 100 is configured in the front side 112. A connection opening for connecting an energy supply cable to the lab-on-a-chip analysis device 100 is configured in the rear side 114. A maintenance interface for carrying out maintenance on the lab-on-a-chip analysis device 100 is configured or arranged in the standing surface side 116.

The standing surface side 116 is here configured to function as a standing surface of the lab-on-a-chip analysis device 100 during operation or normal operation of the lab-on-a-chip analysis device 100. The rear side 114 is configured to function as a further standing surface of the lab-on-a-chip analysis device 100 during maintenance work on the lab-on-a-chip analysis device 100, when the cable has been removed from the connection opening of the rear side 114. Thus, for maintenance work to be carried out, the lab-on-a-chip analysis device 100 can be rotated from the standing surface side 116, functioning as a standing surface during normal operation, to the rear side, functioning as a further standing surface for maintenance, wherein any cable that is present must be removed from the connection opening of the rear side 114 in order to allow the rear side 114 to be used as a further standing surface.

According to the illustrative embodiment shown here, the rear side 114 and the standing surface side 116 are configured as mutually adjoining surfaces or sides of the housing 110. The rear side 114 and the standing surface side 116 in this case have a common edge 118. According to the illustrative embodiment shown here, the common edge 118 is rounded.

As can be seen among other things from the view shown in FIG. 1, the housing 110 additionally has further sides, such that a side view of the lab-on-a-chip analysis device 100 reveals, solely by way of example, a contour of the housing 110 in the form of an irregular pentagon.

According to one illustrative embodiment, the front side 112 is inclined and the rear side is oriented vertically when the lab-on-a-chip analysis device 100 is standing, in the state ready for operation, on the standing surface side 116.

FIG. 2 shows a schematic view of the lab-on-a-chip analysis device 100 of FIG. 1 from another perspective. Here, the lab-on-a-chip analysis device 100, in particular the housing 110, is shown in a side view. Of the lab-on-a-chip analysis device 100, the view in FIG. 2 shows the housing 110 with the front side 112, the rear side 114, the standing surface side 116 and the common edge 118. The contour of the housing 110 in the form of an irregular pentagon can also be seen from the view in FIG. 2. Here, a right angle is spanned between the rear side 114 and the standing surface side 116. According to another illustrative embodiment, an acute angle can be spanned between the rear side 114 and the standing surface side 116.

FIG. 3 shows a schematic view of the lab-on-a-chip analysis device 100 of FIG. 1 or FIG. 2 from another perspective. The lab-on-a-chip analysis device 100, in particular the housing 110, is shown here in a rear view. Of the lab-on-a-chip analysis device 100, the view in FIG. 3 shows the housing 110 with the rear side 114, the common edge 118, the connection opening 313 and a further connection opening 315.

The connection opening 313 for connecting an energy supply cable to the lab-on-a-chip analysis device 100 is formed in the rear side 114. A connector socket of the lab-on-a-chip analysis device 100 for the cable is accessible through the connection opening 313. In particular, according to the illustrative embodiment shown here, a connector socket for a cold appliance plug of the cable is accessible. The connection opening 313 is arranged adjacent to the common edge 118. To be more exact, the connection opening 313 is formed in a third of the rear side 114 of the housing 110 adjoining the common edge 118.

According to the illustrative embodiment shown here, the housing 110 has the further connection opening 315 for connecting at least one further cable, for data transmission, to the lab-on-a-chip analysis device 100. The further connection opening 315 is configured or arranged adjacent to the connection opening 313 for connecting the energy supply cable.

FIG. 4 shows a schematic view of the lab-on-a-chip analysis device 100 of FIG. 1, FIG. 2 or FIG. 3 from another perspective. The lab-on-a-chip analysis device 100, in particular the housing 110, is shown here in a bottom view. Of the lab-on-a-chip analysis device 100, the view in FIG. 4 shows the housing 110 with the standing surface side 116, the common edge 118, the maintenance interface 417, elastic elements 420, a window 430 and a device label 440.

The maintenance interface 417 is configured or arranged in the standing surface side 116, which functions as the standing surface during operation or normal operation of the lab-on-a-chip analysis device 100. Maintenance work or maintenance procedures can be carried out on the lab-on-a-chip analysis device 100 via the maintenance interface 417. According to the illustrative embodiment shown here, the maintenance interface 417 has a flap by means of which an air filter of the lab-on-a-chip analysis device 100 can be made accessible for maintenance work. Additionally or alternatively, the maintenance interface 417 can have a flap by means of which a housing interior and/or another functional component, for example at least one sealing element, in particular a sealing lip, of the lab-on-a-chip analysis device 100 can be made accessible for maintenance work.

According to the illustrative embodiment shown here, the housing 110 has three elastic elements 420. The elastic elements 420 here function as support feet for the lab-on-a-chip analysis device 100. The elastic elements 420 are formed, for example, from rubber or another elastic material. The elastic elements 420 extend over a portion of the standing surface side 116 and/or a portion of the rear side of the housing 110. To be more exact, one of the elastic elements 420 extends over a portion of the standing surface side 116, and two of the elastic elements 420 extend over a portion of the standing surface side 116 and over a portion of the rear side of the housing 110.

Of the housing 110, the view in FIG. 4 also shows the window 430 and the device label 440. The window 430 is provided for a reader for reading optoelectronically readable symbols on cartridges. The window 430 is configured in a further side of the housing 110 adjoining the standing surface side 116. The optoelectronically readable symbols are, for example, barcodes or the like. The label device 440 is arranged on the standing surface side 116, in particular adjacent to the maintenance interface 417.

FIG. 5 shows a schematic view of a portion of the lab-on-a-chip analysis device 100 of FIG. 1, FIG. 2, FIG. 3 or FIG. 4. The lab-on-a-chip analysis device 100, in particular the housing 110, is shown here in an oblique rear view. Of the lab-on-a-chip analysis device 100, the view in FIG. 5 shows a portion of the housing 110 with the rear side 114, the common edge 118, the connection opening 313, the further connection opening 315, an energy supply cable 550, and a further cable 560 for data transmission. The view in FIG. 5 is similar to the view in FIG. 3, while additionally showing the cable 550 and the further cable 560. According to the illustrative embodiment shown here, the cable 550 has a cold appliance plug. Arrows symbolically illustrate that the cable 550 is removed or pulled out from the connection opening 313, and the further cable 560 from the further connection opening 315, in order to be able to tilt the lab-on-a-chip analysis device 100, for maintenance work, from the standing surface side to the rear side 114.

FIG. 6 shows a schematic view of the lab-on-a-chip analysis device 100 of FIG. 1, FIG. 2, FIG. 3 or FIG. 4 during tilting from the standing surface to the further standing surface. The lab-on-a-chip analysis device 100, in particular the housing 110, is shown here in a side view. Of the lab-on-a-chip analysis device 100, the view in FIG. 6 shows the housing 110 with the front side 112, the rear side 114, the standing surface side 116 and the common edge 118. An arrow symbolically indicates the tilting process or a tilting movement of the lab-on-a-chip analysis device 100. During the tilting process, the lab-on-a-chip analysis device 100 is tilted about the common edge 118 from the standing surface side 116, functioning as the standing surface during normal operation, to the rear side 114, functioning as the further standing surface for maintenance work.

FIG. 7 shows a schematic view of the lab-on-a-chip analysis device 100 of FIG. 1, FIG. 2, FIG. 3, FIG. 4 or FIG. 6 at the start of a maintenance procedure. The lab-on-a-chip analysis device 100, in particular the housing 110, is shown here in an oblique side view, standing on the rear side 114 functioning as the further standing surface. Of the lab-on-a-chip analysis device 100, the view in FIG. 7 shows the housing 110 with the front side 112, the rear side 114, the standing surface side 116, the common edge 118, the maintenance interface 417 in the form of a filter flap, and a used air filter 770. The maintenance interface 417 or filter flap is shown open in the view in FIG. 7. Arrow symbols and a trashcan symbol illustrate that the used air filter 770 is disposed of.

FIG. 8 shows a schematic view of the lab-on-a-chip analysis device 100 of FIG. 1, FIG. 2, FIG. 3, FIG. 4, FIG. 6 or FIG. 7 at the end of the maintenance procedure. The view in FIG. 8 corresponds here to the view in FIG. 7, except that, instead of the used air filter, a new air filter 870 is shown. An arrow symbolically indicates that the new air filter 870 is inserted into the lab-on-a-chip analysis device 100.

In summary, and to put it in other words, a lab-on-a-chip analysis device 100 is shown in FIGS. 1 to 8, wherein the lab-on-a-chip analysis device 100 is depicted, for example in FIGS. 1, 2 and 5, during normal operation and in a standing position on the standing surface side 116 as standing surface. The connection opening 313, for example for a cold appliance plug, is arranged in the rear side 114, in the illustrative embodiment shown here in a region of the rear side 114 adjoining the common edge 118, in order to run an electrical voltage supply as close as possible to a laboratory bench and to enforce or encourage a reliable separation of the voltage supply prior to the maintenance work. FIG. 2 in particular shows the rounding or the rounded common edge 118 between the rear side 114 and the standing surface side 116. In the event of servicing and/or repair work, or for maintenance procedures, the lab-on-a-chip analysis device 100 is rolled over this rounding or rounded common edge 118. According to the illustrative embodiment shown here, circumferential elastic elements 420 or rubber feet extend across the rounded common edge 118, in order to facilitate tilting of the lab-on-a-chip analysis device 100 from the standing surface side 116 to the rear side 114. With a cold appliance plug of the cable 550 inserted into the connection opening 313 and thus protruding therefrom, the lab-on-a-chip analysis device 100 can be tilted only when this cold appliance plug is pulled out from the connection opening 313 prior to the tilting procedure. The voltage supply is thus separated completely from the lab-on-a-chip analysis device 100.

FIG. 4 also shows the maintenance interface 417 configured as a filter flap which, for example in the event of repair work, has to be opened in order to replace the used air filter 770 with the new air filter 870. Only after the lab-on-a-chip analysis device 100 has been tilted onto the rear side as further standing surface 114 does a user or service technician gain access to the maintenance interface 417, for example a filter unit. When the maintenance interface 417 or filter flap is opened and the filter mat or the used air filter 770 is removed, the voltage supply is separated, and the fan arranged under the air filter 770 or 870, and rotating during normal operation, is stationary. This avoids a situation where the user touches rotating or moving structural parts. FIG. 4 likewise shows the elastic elements 420 or rubber feet or rubber bumpers which serve to ensure that the lab-on-a-chip analysis device 100 stands securely during normal operation and which, on account of the circumferential configuration on the rear side 114, also facilitate the tilting to the rear side 114 of the lab-on-a-chip analysis device 100.

FIGS. 5 to 8 further outline the sequence of the procedure involved in preparing for and performing maintenance work, for example shown for replacement of the filter 770 or 870 in the event of repairs. FIG. 5 shows the pulling of the cable 550 with the cold appliance plug, which is intended to be done before the lab-on-a-chip analysis device 100 as shown in FIG. 5 can be tilted onto the rear side 114 of the housing 110. As is shown in FIG. 7, the maintenance interface 417 or filter flap is then opened, and the used air filter 770 is removed and exchanged. At the moment the latter is exchanged, the fan is stationary and the lab-on-a-chip analysis device 100 is free of current. After the exchange, or after other repair/service work has been performed, and the maintenance interface 417 has been closed, the lab-on-a-chip analysis device 100 is tilted back onto the standing surface side 116, the cable 550 with the cold appliance plug is connected again to the connection opening 313, and the lab-on-a-chip analysis device 100 can be operated normally again.

Where an illustrative embodiment comprises an “and/or” link between a first feature and a second feature, this is to be understood as meaning that the illustrative embodiment, in one form, has both the first feature and also the second feature and, in another form, has either only the first feature or only the second feature.

1. A housing for a lab-on-a-chip analysis device, comprising:
a cartridge opening configured to receive a cartridge, which has material to be analyzed, into the lab-on-a-chip analysis device;
a rear side having a connection opening configured for connecting an energy supply cable to the lab-on-a-chip analysis device; and
a standing surface side having a maintenance interface configured to enable maintenance on the lab-on-a-chip analysis device, the standing surface side being configured as a standing surface of the lab-on-a-chip analysis device during operation of the lab-on-a-chip analysis device,
wherein the rear side is configured to function as a further standing surface of the lab-on-a-chip analysis device when the cable is removed from the connection opening and the lab-on-a-chip analysis device is undergoing maintenance.

2. The housing as claimed in claim 1, wherein the rear side and the standing surface side are surfaces adjoining each other and having a common edge.

3. The housing as claimed in claim 2, wherein the connection opening is arranged adjacent to the common edge.

4. The housing as claimed in claim 2, wherein the common edge is rounded.

5. The housing as claimed in claim 1, wherein the rear side and the standing surface side define an acute angle or a right angle.

6. The housing as claimed in claim 1, further comprising:
at least one elastic element which extends over a portion of the standing surface side and/or a portion of the rear side.

7. The housing as claimed in claim 1, wherein the maintenance interface has at least one flap, configured to enable access to a housing interior, an air filter and/or another functional component of the lab-on-a-chip analysis device for maintenance.

8. The housing as claimed in claim 1, further comprising:
a further connection opening configured for connecting at least one further cable, which is configured for data transmission, to the lab-on-a-chip analysis device.

9. The housing as claimed in claim 1, further comprising:
a window for a reader for reading optoelectronically readable symbols.

10. A lab-on-a-chip analysis device comprising:
a housing comprising:
a cartridge opening configured to receive a cartridge, which has material to be analyzed, into the lab-on-a-chip analysis device
a rear side having a connection opening configured for connecting an energy supply cable to the lab-on-a-chip analysis device; and
a standing surface side having a maintenance interface configured to enable maintenance on the lab-on-a-chip analysis device, the standing surface side being configured as a standing surface of the lab-on-a-chip analysis device during operation of the lab-on-a-chip analysis device,
wherein the rear side is configured to function as a further standing surface of the lab-on-a-chip analysis device when the cable is removed from the connection opening and the lab-on-a-chip analysis device is undergoing maintenance.
